(19) United States
(12) Patent Application Publication
(10) Pub. No.: US 2006/0212143 A1
(43) Pub. Date: Sep. 21, 2006

(54) Apparatus and methods for instant messaging feature for communication between users in multiple-user information handling system

(76) Inventors: Dung Hoan Nguyen, Austin, TX (US); Alaa Yousif, Pflugerville, TX (US)

Correspondence Address: O'KEEFE, EGAN & PETERMAN, 1101 CAPITAL OF TEXAS HIGHWAY SOUTH, #C200, AUSTIN, TX, 78746, US

(21) Appl. No.: 11/069,283

(22) Filed: Mar. 1, 2005

(51) Int. Cl. G05B 19/18; G05B 15/02

(52) U.S. Cl. 700/65; 700/66; 700/9

(57) ABSTRACT

An information handling system includes a host computer and a remote access controller. A plurality of remote users communicate with the host computer. The remote access controller communicates an instant message from one of the remote users to one or more of the remote users. The instant message communicates information related to administration, use, access, and/or management of the at least one resource of the host computer.

### TECHNICAL FIELD

The inventive concepts relate generally to information handling apparatus and systems. More particularly, the invention concerns apparatus and associated methods for providing an instant messaging feature to users in a multiple-user information handling or computer system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To provide more flexibility and productivity, information handling systems sometimes provide access to multiple users. The users may use the system to perform various tasks. When multiple remote users use an information handling system, conflicts among the users may arise with respect to use of system resources, tasks performed, and the like. In order to avoid such conflicts or inform or warn other users, a need exists for the users to communicate with one another in a relatively efficient, reliable, and fast manner.

### SUMMARY

The disclosed novel concepts relate to apparatus and methods for providing instant messaging among remote users of an information handling system. In one exemplary embodiment, an information handling system includes a host computer and a remote access controller. A plurality of remote users communicate with the host computer. The remote access controller communicates an instant message from one of the remote users to one or more of the remote users. The instant message communicates information related to administration, use and/or management of the at least one resource of the host computer. In another exemplary embodiment, the instant message communicates a request for access to the at least one resource of the host computer.

In yet another embodiment, a method of providing a communication mechanism in an information handling system, which includes at least one resource, includes maintaining a list of a plurality of remote users of the information handling system. The method further includes receiving an instant message from one of the users, and transmitting the instant message to one or more of the users. The instant message includes information about use, administration, or access to the at least one resource of the information handling system.

### BRIEF DESCRIPTION OF THE DRAWINGS

The appended drawings illustrate only exemplary embodiments of the invention and therefore should not be considered or construed as limiting its scope. Persons of ordinary skill in the art who have the benefit of the description of the invention appreciate that the disclosed inventive concepts lend themselves to other equally effective embodiments. In the drawings, the same numeral designators used in more than one drawing denote the same, similar, or equivalent functionality, components, or blocks.

FIG. 1 shows an information handling system according to an exemplary embodiment of the invention.

FIG. 2 illustrates more details of the information handling system of FIG. 1.

FIG. 3 depicts a block diagram of an arrangement for providing instant messaging among system users according to an exemplary embodiment of the invention.

FIG. 4 shows an illustrative embodiment according to the invention for communication between a remote user and a remote access controller in the information handling system.

FIG. 5 illustrates a process flow for communication between remote users and an information handling system in order to facilitate instant messaging according to the invention.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

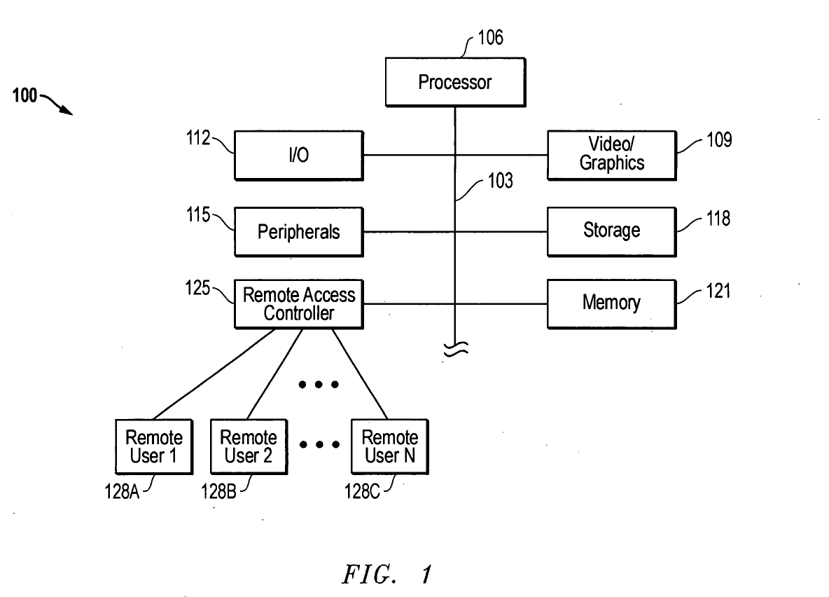

FIG. 1 shows an information handling system 100 according to an exemplary embodiment of the invention. Generally speaking, system 100 may constitute a host or server computer system, as desired. System 100 includes one or more processors 106, one or more buses or communication media 103, video/graphics hardware 109, storage 118, memory 121, input/output (I/O) 112, peripherals 115, and remote access controller 125.

Bus 103 provides a mechanism for the various components of system 100 to communication and couple with one another and thus acts as the backbone of the system. Processor 106, video/graphics 109, storage 118, memory 121, I/O 112, and peripherals 115 have the structure, and perform the functions, familiar to persons of ordinary skill in the art who have the benefit of the description of the invention.

Note that FIG. 1 provides merely an illustrative architecture of system 100. One may readily use alternative architectures or structures, and yet take advantage of the inventive concepts, by making modifications that fall within the knowledge of persons of ordinary skill in the art who have the benefit of the description of the invention.

Remote access controller 125 accommodates access by a plurality of remote users 128A-128C. Remote access controller 125 allows remote users to manage, administer, use, and/or access various resources of host system 100 (either native or virtual) from a remote location. Remote users 128A-128C may have in-band or out-of-band access to system 100, as desired. For example, remote users 128A-128C may have access through a local area network (LAN), a dial-up modem connection, a wide-area network (WAN), and the like, as desired.

In illustrative embodiments, remote access controller 125 may constitute a Dell Remote Access Controller (DRAC), available from Dell Inc., the assignee of this patent application. Note, however, that one may use other suitable remote access controllers, as persons of ordinary skill in the art who have the benefit of the description of the invention understand.

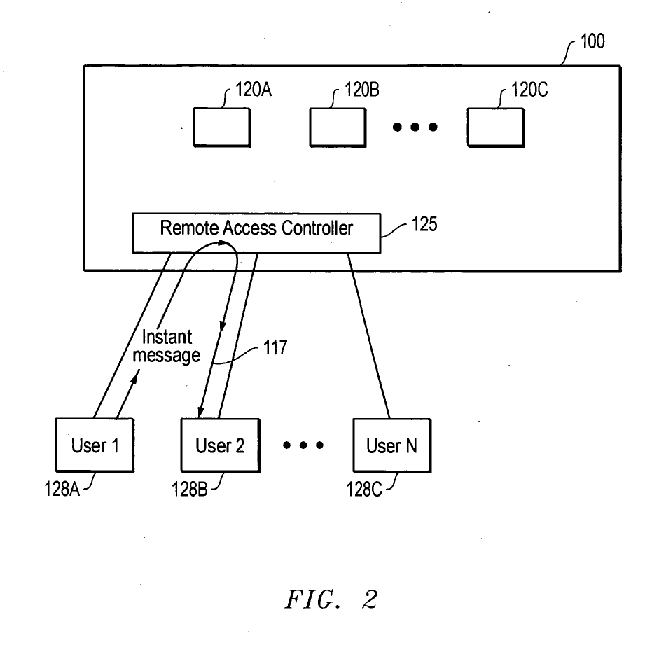

FIG. 2 illustrates more details of system 100, shown in FIG. 1. More specifically, FIG. 2 shows various resources 120A-120C of system 100. Examples of such resources include processing resources, including graphics/video resources, storage and memory resources, computing resources, multimedia resources, various input/output resources (e.g., printer, scanner, and the like), and general hardware resources, such as the basic input/output system (BIOS), timers, etc.

The information handling system may also include software resources. Examples include general-purpose and special-purpose application packages and software, drivers, modules, etc. Note that the information handling system may include virtual resources, as desired, and as persons of ordinary skill in the art who have the benefit of the description of the invention understand. Remote users may wish to access, use, administer, and/or manage resources 120A-120C of system 100 through their respective connections with the system.

During their communications with system 100, one or more of users 128A-128C may wish to communicate with one or more of the other remote users. The nature of the communication may result from a variety of situations and may take many forms, as persons of ordinary skill in the art who have the benefit of the description of the invention understand. Generally speaking, the nature of communication among users may take the form of providing information (e.g., warning, notification, acknowledgement) by a user to one or more other users, or making requests to one or more users. Some illustrative examples follow.

In one situation, one of users 128A-128C may wish to notify other user(s) about a system event, such as scheduled system maintenance, status of various system resources, resources that the user is using, wishes to use, or has finished using, etc. In another scenario, one of users 128A-128C, say, user 128A, may seek to inform other user(s) that he or she wishes access to one or more system resources 120A-120C, or is accessing or using or controlling one of system resources 120A-120C.

Under some situations, simultaneous use, access, administration, or management of one or more system resources 120A-120C may lead to conflict, system instability, or other problems. Even when simultaneous use, access, administration, or management of one or more system resources 120A-120C does not by itself cause a problem, a change or use of a system resource may affect other users. For example, suppose that user 128A wishes to change a BIOS setting, install an operating system, reboot or restart the system, etc. Because such changes affect the operation of a computer system, other users will experience the results of the changes.

In another scenario, user 128A may have higher priority than the other user(s) and may wish to inform them that he or she is taking control of one or more system resources 120A-120C. Communicating that intention to the affected user(s) gives them an opportunity to finish with the affected resource(s) in an orderly manner.

In any of the illustrative situations described above (or other situations), the inventive concepts provide a mechanism for one or more users 128A-128C to communicate with one or more other users with an instant messaging mechanism. For example, user 128A may send an instant message to user 128B via path 117, as FIG. 2 depicts. Note that the above examples constitute merely illustrative situations, and that one may advantageously use instant messaging according to the invention in other situations, as persons of ordinary skill in the art who have the benefit of the description of the invention understand.

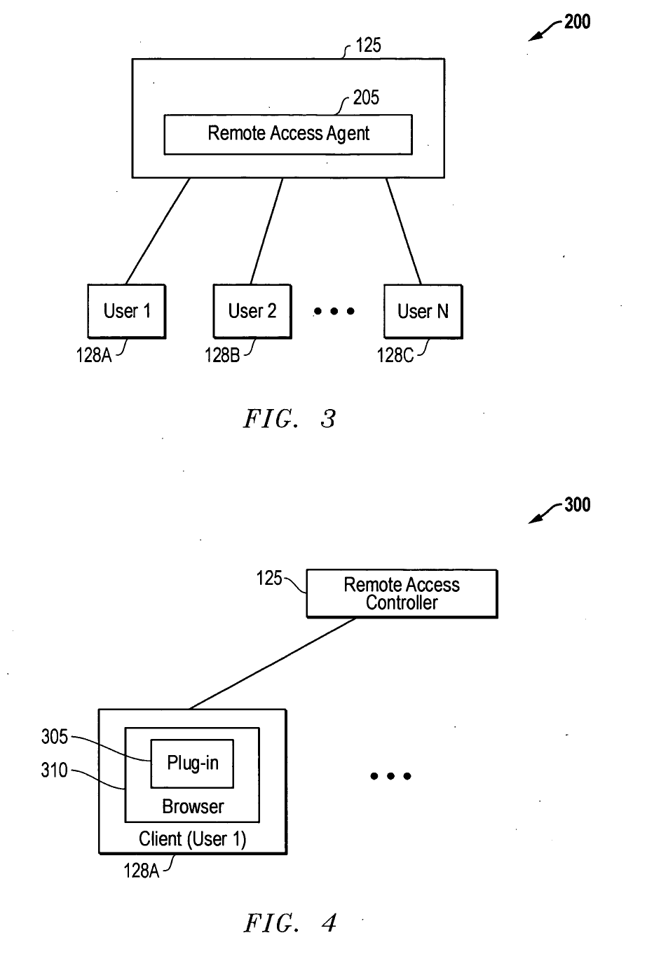

FIG. 3 shows a block diagram of an arrangement for providing instant messaging among system users according to an exemplary embodiment 200 of the invention. More specifically, in embodiment 200, remote access controller 125 includes a remote access agent, circuit, apparatus (in hardware, firmware, software, or a combination of them) 205 in order to facilitate instant messaging in system 100.

In exemplary embodiments, remote access agent 205 maintains a list of logged on users (or users that are accessing, administering, managing, and/or using resources on system 100). By keeping the list of users, remote access agent 205 facilitates routing instant messages from one of users 128A-128C to one or more of users 128A-128C.

The instant messages may constitute a wide variety of formats, contents, communication protocols, etc., as persons of ordinary skill in the art who have the benefit of the description of the invention understand. For example, the instant messages may include text, video, graphics, audio, multimedia, or any combination of them, as desired.

Furthermore, one may use a wide variety of communication protocols for the transmission, routing, and reception of the instant messages, as desired. FIG. 4 shows an illustrative embodiment 300 according to the invention for communication between a remote user and remote access controller 125 in system 100. More specifically, the remote user (say, remote user 128A) may use browser 305 to communicate with remote access controller 125. Browser 305 may include plug-in 310 to facilitate communication with remote access controller 125.

One may user a variety of protocols, such as the Hyper Text Transfer Protocol, or HTTP (the protocol used by the World Wide Web protocol) to communicate with remote access controller 125. Typical computer systems include browsers with built-in HTTP capability. Remote user 128A can exploit this capability and use his or her browser's HTTP protocol to communicate with system 100 and, more specifically, with remote access controller 125.

As another example, remote user 128A can use the Hyper Text Transfer Protocol Secure sockets, or HTTPS, to communicate with remote access controller 125. The browser included with a typical computer systems has built-in HTTPS capability. Remote user 128B can use the built-in capability of the browser and communicate with system 100 using the HTTPS protocol.

Note that the HTTPS protocol allows secure communication between remote user 128A and system 100. The secure communication can facilitate tasks such as authentication of remote user 128B, transmission of sensitive information between host system 100 and remote user 128A as part of the instant message.

If desired, one may use other protocols to communicate with system 100. For example, user 128A may wish to use a protocol other than HTTP or HTTPS to access system 100. The inventive concepts contemplate the capability within remote access controller 125 to accommodate additional or different protocols, as desired. This capability provides the remote user with a flexible mechanism to communicate with system 100.

As another example, one may use the voice over IP (VoIP) to provide communication between a remote user and system 100, as desired. VoIP allows instant messaging via voice messages. The remote user may use a microphone and exploit the VoIP protocol to send instant messages to other remote users.

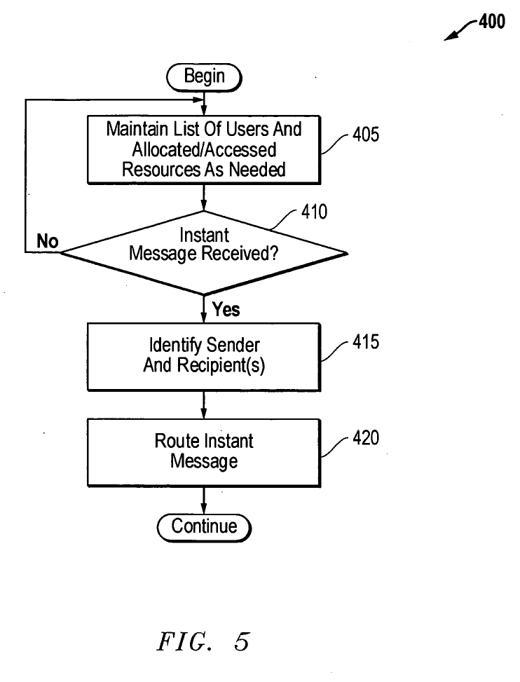

FIG. 5 shows a process flow 400 for communication between remote users and an information handling system in order to facilitate instant messaging according to the invention. At 405, system 100 maintains a list of remote users logged in or communicating with the system. Optionally, system 100 can maintain a list of resources that each of the remote users is using, accessing, administering, and/or managing. As remote users log in or out of the system, the system adjusts and updates its list appropriately.

At 410, the system checks to determine whether it has received an instant message from one of the remote users. If not, the system returns to 405 (or continues checking at 410, as desired). If the system has received an instant message, at 415, it identifies the sender and the recipient(s) of the instant message. Note that the system may optionally conduct various processing, such as checking the authentication and privileges of the users, logging the instant message, and the like, as desired.

Once it has identified the recipient(s) of the instant message, at 420, the system routes the instant message to the appropriate recipient(s). The system may then continue with other information handling tasks, or return to 405 or 410, as desired.

Referring to the figures, persons of ordinary skill in the art will note that the various blocks shown may depict mainly the conceptual functions and signal flow. The actual circuit implementation may or may not contain separately identifiable hardware for the various functional blocks and may or may not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation, as persons of ordinary skill in the art who have the benefit of the description of the invention understand. Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred or illustrative embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

1. An information handling system, comprising:
a host computer, having at least one resource;
a plurality of remote users in communication with the host computer; and
a remote access controller, the remote access controller configured to communicate an instant message from a first remote user in the plurality of remote users to a second remote user in the plurality of remote users,
wherein the instant message communicates information related to administration or use of the at least one resource of the host computer.

2. The information handling system according to claim 1, wherein the at least one resource comprises a software resource.

3. The information handling system according to claim 1, wherein the at least one resource comprises a hardware resource.

4. The information handling system according to claim 1, wherein the remote access controller comprises a remote access agent, the remote access agent configured to facilitate communication of the instant message from the first user to the second user.

5. The information handling system according to claim 4, wherein the remote access agent is further configured to maintain a list of the plurality of remote users.

6. The information handling system according to claim 5, wherein each of the first and second users uses a browser to communicate with the remote access controller.

7. The information handling system according to claim 1, wherein the instant message comprises text, video, graphics, voice, or multimedia.

8. An information handling system, comprising:
a host computer, having at least one resource;
a plurality of remote users in communication with the host computer; and
a remote access controller, the remote access controller configured to communicate an instant message from a first remote user in the plurality of remote users to a second remote user in the plurality of remote users,
wherein the instant message communicates a request for access to the at least one resource of the host computer.

9. The information handling system according to claim 8, wherein the remote access controller comprises a remote access agent, the remote access agent configured to facilitate communication of the instant message from the first user to the second user.

10. The information handling system according to claim 9, wherein the remote access agent is further configured to maintain a list of the plurality of remote users.

11. The information handling system according to claim 10, wherein each of the first and second users communicates with the remote access controller by using a computer system that includes a browser.

12. The information handling system according to claim 11, wherein the browser comprises a plug-in configured to facilitate communication with the remote access controller.

13. The information handling system according to claim 12, wherein the browser communicates with the remote access controller by using Hyper Text Transfer Protocol, or HTTP (HTTP).

14. The information handling system according to claim 12, wherein the browser communicates with the remote access controller by using Hyper Text Transfer Protocol Secure sockets (HTTPS).

15. A method of providing a communication mechanism in an information handling system that includes at least one resource, the method comprising:
maintaining a list of a plurality of remote users of the information handling system;
receiving an instant message from a first user in the plurality of remote users; and
transmitting the instant message to a second user in the plurality of remote users,
wherein the instant message comprises information about use, administration, or access to the at least one resource of the information handling system.

16. The method according to claim 15, wherein receiving an instant message from the first user in the plurality of remote users further comprises identifying the first user as the source of the instant message.

17. The method according to claim 16, wherein transmitting the instant message to the second user in the plurality of remote users further comprises identifying the second user as a recipient of the instant message.

18. The method according to claim 15, further comprising authenticating at least one of the first and second users.

19. The method according to claim 15, wherein maintaining the list of the plurality of remote users of the information handling system further comprising updating the list of the plurality of users.

20. The method according to claim 15, wherein the instant message comprises text, video, graphics, voice, or multimedia.
